(19) United States
(12) Patent Application Publication
(10) Pub. No.: US 2004/0228535 A1
(43) Pub. Date: Nov. 18, 2004

(54) Moving image decoding apparatus and moving image decoding method

(75) Inventors: Yoshimasa Honda, Kamakura-shi (JP); Tsutomu Uenoyama, Kawasaki-shi (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD, Osaka (JP)

(21) Appl. No.: 10/837,668

(22) Filed: May 4, 2004

(30) Foreign Application Priority Data
May 15, 2003 (JP) 2003-137838

(51) Int. Cl. G06K 9/34; G06K 9/36

(52) U.S. Cl. 382/233; 382/240

(57) ABSTRACT

A video decoding apparatus that adaptively controls post-filter filter parameters according to a characteristic quantity of priority-coded data priority-coded for individual areas classified by importance within a moving image, and improves the subjective image quality of an overall screen. In a video decoding apparatus 200, a filter parameter calculation section 213 calculates filter parameters that control the noise elimination intensity of a post-filter processing section 215 based on shift values of individual small areas set in a stepwise shift map in which the shift value decreases stepwise from an important area to the peripheral area within a screen in the video coding apparatus, and a post-filter processing section 215 performs post-filter processing of a reconstructed image by applying the calculated filter parameters.

### BACKGROUND OF THE INVENTION

1. Field of the Invention

The present invention relates to a moving image decoding apparatus and moving image decoding method whereby priority-coded data is decoded by area basis according to importance.

2. Description of the Related Art

Video data transmitted in a conventional video transmission system is usually compressed in a certain band or less by means of the H.261 scheme, MPEG (Moving Picture Experts Group) scheme, or the like, so as to be able to be transmitted in a certain transmission band, and once video data has been coded, the video quality cannot be changed even if the transmission band changes.

However, with the diversification of networks in recent years, transmission path band fluctuations have increased and video data that allows transmission of video of quality matched with a plurality of bands has become necessary. In response to this need, layered coding schemes that have a layered structure and can handle a plurality of bands have been standardized.

Among such layered coding schemes, MPEG-4 FGS (ISO/IEC 14496-2 Amendment 2), a scheme with a particularly high degree of freedom in terms of bit-rate selection, is now being standardized.

Video data coded by means of MPEG-4 FGS is composed of a base layer comprising a moving image stream that can be coded as a unit, and one or more enhancement layers comprising a moving image stream for improving the base layer moving image quality. The base layer is low-bit rate, low-quality video data, and by adding an enhancement layer to the base layer according to the network available band, it is possible to achieve high image quality with a high degree of freedom, and implement high moving image quality even in a low band.

If, for example, by using this layered coding scheme, the inside of a moving image is divided into an area that is important for the user and another peripheral area and a DCT coefficient is set that is bit-shifted adaptively, and coding processing is executed so that coding is performed on a priority basis starting from the important area, coding processing whereby coding is performed on a priority basis starting from an important area is possible, and higher image quality can be achieved stepwise starting from an important area.

As a means of reducing the processing load in coding and decoding, an apparatus has been proposed that speeds up coding processing and decoding processing without degrading moving image quality in a hybrid coding scheme that uses motion compensation prediction (MC) and discrete cosine transform (DCT) basically adopted by the MPEG2 scheme and MPEG4 scheme (see, for example, Unexamined Japanese Patent Publication No. 2001-245297 (claim 1 and claim 5)).

In this apparatus, when coding processing is performed, the coding processing load can be reduced without loss of quality by deciding whether to perform half-pixel precision motion vector detection operation or to perform integer-pixel precise motion vector detection operation according to whether or not a quantization parameter for quantizing a DCT coefficient is greater than a certain threshold value.

Also, in this apparatus, when decoding processing is performed, decoding processing can be performed without loss of quality of a high-image-quality area with a small quantization parameter by performing on/off control of post-filter processing according to whether or not the quantization parameter is greater than a preset threshold value.

Therefore, by applying the above-described coding processing when coding a moving image using a layered coding scheme, and applying the above-described decoding processing when decoding layeredly coded data, it is possible to maintain the image quality of a high-image-quality area.

However, if post-filter on/off control is performed based on a quantization parameter when decoding priority-coded data in which an important area of a moving image is priority-coded using a layered coding scheme, there is a problem in that the degradation of the decoded image of the peripheral area is noticeable in comparison with the image quality of the decoded image of the important area, and subjective image quality declines.

That is to say, when coding is performed on a priority basis starting from an important area by dividing the inside of a moving image into areas that are important for the user and other peripheral areas and setting a DCT coefficient that is bit-shifted adaptively, with regard to quantization parameter setting, a difference arises between the important area and peripheral area, a big difference in image quality arises within the moving image, and image quality degradation is particularly great for a peripheral area that is not priority-coded, with the result that, if post-filter filter processing is applied overall according to the DCT coefficient and quantization parameter settings in priority coding, although overall image noise can be reduced, the sharpness of the image in the priority-coded area is lost.

### SUMMARY OF THE INVENTION

It is an object of the present invention to provide a moving image decoding apparatus and moving image decoding scheme whereby a post-filter filter parameter is controlled adaptively according to a characteristic quantity of priority-coded data in which the inside of a moving image is priority-coded for individual areas classified by importance, and the subjective image quality of an overall screen is improved.

According to an aspect of the invention, a moving image decoding apparatus that decodes priority-coded data in which a moving image is priority-coded on an area-by-area basis has a calculation section that calculates a filter parameter of a post-filter that reduces a noise component based on a characteristic quantity set for the priority-coded data, and a post-filter processing section that applies the filter parameter to a post-filter and reduces a noise component of decoded data of the priority-coded data.

According to another aspect of the invention, a moving image decoding scheme that decodes priority-coded data in which a moving image is priority-coded on an area-by-area basis has a calculation step of calculating a filter parameter of a post-filter that reduces a noise component based on a characteristic quantity set for the priority-coded data, and a post-filter processing step of applying the filter parameter to a post-filter and reducing a noise component of decoded data of the priority-coded data.

### BRIEF DESCRIPTION OF THE DRAWINGS

The above and other objects and features of the invention will appear more fully hereinafter from a consideration of the following description taken in conjunction with the accompanying drawings wherein examples are illustrated by way of example, in which:

FIG. 1 is a block diagram showing the configuration of a video coding apparatus according to Embodiment 1 of the present invention;

FIG. 2 is a block diagram showing the configuration of a video decoding apparatus according to Embodiment 1;

FIG. 3 is a flowchart for explaining the operation of a video decoding apparatus according to Embodiment 1;

FIG. 4A is a drawing showing an example of a stepwise shift map according to Embodiment 1;

FIG. 4B is a drawing showing an example of a filter intensity map according to Embodiment 1;

FIG. 5 is a drawing showing an example of a filter intensity table according to Embodiment 1;

FIG. 6 is a block diagram showing the configuration of a video decoding apparatus according to Embodiment 2 of the present invention;

FIG. 7 is a flowchart for explaining the operation of a video decoding apparatus according to Embodiment 2;

FIG. 8A is a drawing showing examples of a stepwise shift map and received bit amount proportion map according to Embodiment 2;

FIG. 8B is a drawing showing an example of a filter intensity map according to Embodiment 2;

FIG. 9 is a drawing showing an example of a filter intensity table according to Embodiment 2;

FIG. 10 is a block diagram showing the configuration of a video decoding apparatus according to Embodiment 3 of the present invention;

FIG. 11 is a flowchart for explaining the operation of a video decoding apparatus according to Embodiment 3;

FIG. 12A is a drawing showing an example of a stepwise shift map according to Embodiment 3;

FIG. 12B is a drawing showing an example of a filter intensity map according to Embodiment 3;

FIG. 13A is a drawing showing an example of filter intensities before modification according to Embodiment 3;

FIG. 13B is a drawing showing an example of filter intensities after modification according to Embodiment 3;

FIG. 14 is a block diagram showing the configuration of a video decoding apparatus according to Embodiment 4 of the present invention;

FIG. 15 is a flowchart for explaining the operation of a video decoding apparatus according to Embodiment 4;

FIG. 16A is a drawing showing an example of a stepwise shift map according to Embodiment 4;

FIG. 16B is a drawing showing an example of a filter intensity map according to Embodiment 4;

FIG. 17A is a drawing showing an example of filter intensities before modification according to Embodiment 4;

FIG. 17B is a drawing showing an example of filter intensities of one frame before according to Embodiment 4; and

FIG. 17C is a drawing showing an example of filter intensities after modification according to Embodiment 4.

### DESCRIPTION OF THE PREFERRED EMBODIMENTS

The gist of the present invention is that a post-filter filter parameter is controlled adaptively according to a characteristic quantity of priority-coded data in which a moving image is priority-coded by area basis according to its importance, and the subjective image quality of an overall screen is improved.

With reference now to the accompanying drawings, embodiments of the present invention will be explained in detail below.

(Embodiment 1)

In this embodiment, a video decoding apparatus is described to which is applied a moving image decoding scheme whereby a filter parameter that controls the noise elimination intensity of a post-filter is calculated based on a bit-shift value set when performing coding on an individual small area basis, a filter parameter used when performing post-filter processing of a decoded image on an individual small area basis can be controlled adaptively, and the subjective image quality of an overall screen can be improved.

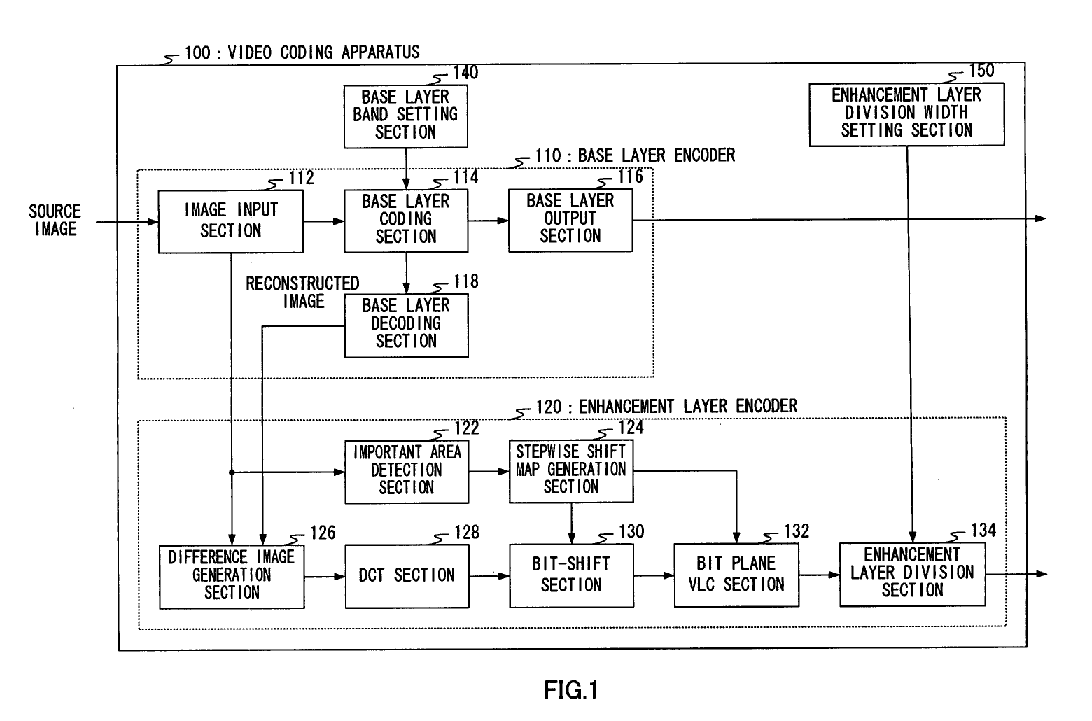

FIG. 1 is a block diagram showing the configuration of a video coding apparatus to which a moving image coding scheme according to Embodiment 1 of the present invention is applied.

Video coding apparatus 100 shown in FIG. 1 has a base layer encoder 110 that generates a base layer, an enhancement layer encoder 120 that generates an enhancement layer, a base layer band setting section 140 that sets the band of the base layer, and an enhancement layer division band width setting section 150 that sets the division bandwidth of an enhancement layer.

Base layer encoder 110 has an image input section 112 to which an image (source image) is input on an image-by-image basis, a base layer coding section 114 that performs base layer coding, a base layer output section 116 that performs base layer output, and a base layer decoding section 118 that performs base layer decoding.

Enhancement layer encoder 120 has an important area detection section 122 that performs detection of an important area, a stepwise shift map generation section 124 that generates a stepwise shift map from important area information, a difference image generation section 126 that generates a difference image between an input image and base layer's decoded image (reconstructed image), a DCT section 128 that performs DCT processing, a bit-shift section 130 that performs a bit-shift operation of DCT coefficient in accordance with a shift map output from stepwise shift map generation section 124, a bit plane VLC section 132 that performs variable length coding (VLC) on the DCT coefficient for each bit plane, and an enhancement layer division section 134 that performs data division processing of a variable-length-coded enhancement layer using a division band width input from enhancement layer division band width setting section 150.

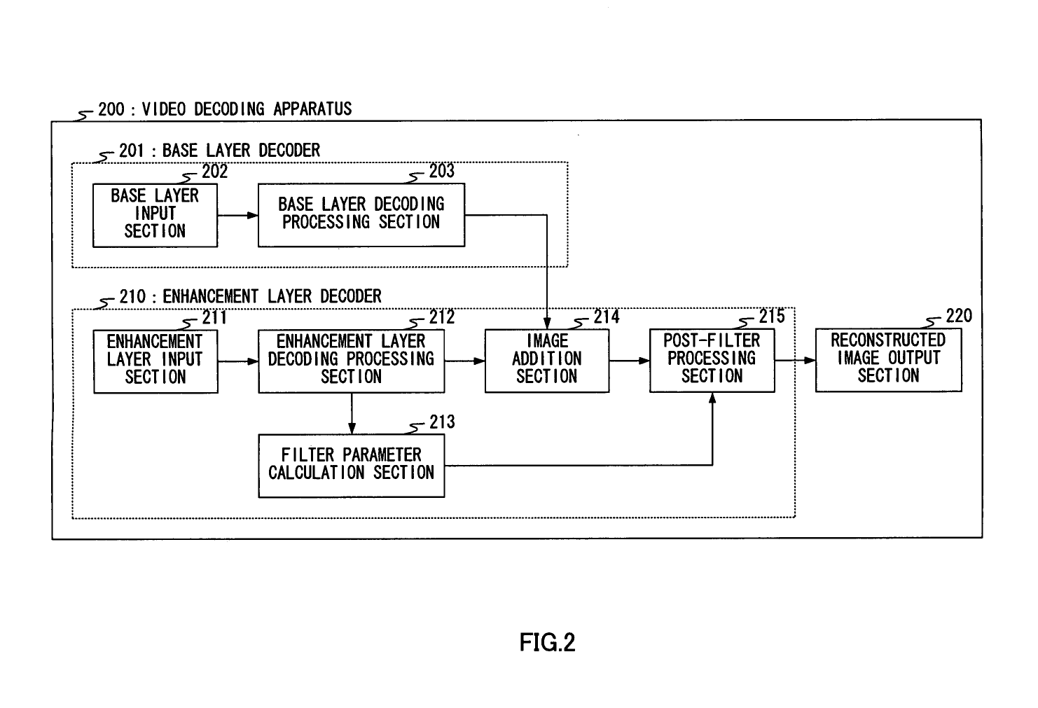

FIG. 2 is a block diagram showing the configuration of a video decoding apparatus to which a moving image coding scheme according to Embodiment 1 of the present invention is applied.

Video decoding apparatus 200 has a base layer decoder 201 that decodes abase layer, an enhancement layer decoder 210 that decodes an enhancement layer, and a reconstructed image output section 220 that reconstructs and outputs a decoded image.

Base layer decoder 201 has a base layer input section 202 that inputs a base layer, and a base layer decoding processing section 203 that performs decoding processing on the input base layer.

Enhancement layer decoder 210 has an enhancement layer input section 211 that inputs an enhancement layer, an enhancement layer decoding processing section 212 that performs input enhancement layer decoding processing and shift value decoding processing, a filter parameter calculation section 213 that calculates a filter parameter by using the shift value, an image addition section 214 that adds a base layer's decoded image and enhancement layer's decoded image, and a post-filter processing section 215 that adjusts the noise elimination intensity by means of the calculated filter parameter and performs filter processing on the added decoded image.

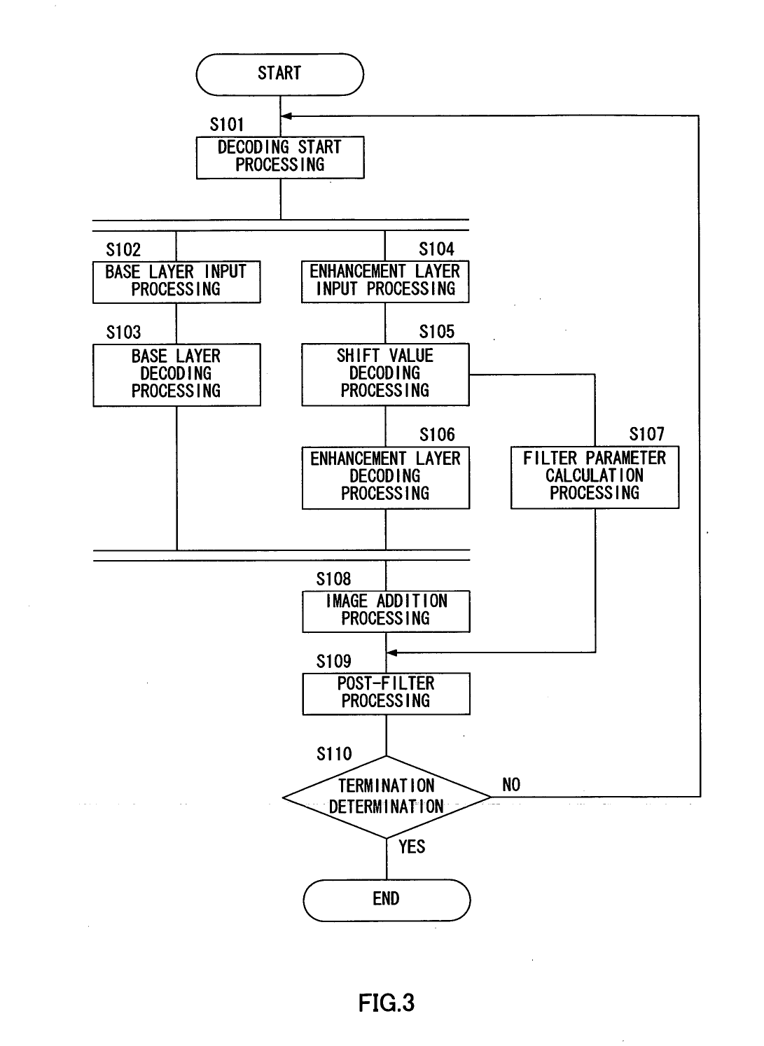

Next, the operation of video decoding apparatus 200 with the above configuration will be described, using the flowchart shown in FIG. 3. The flowchart in FIG. 3 is stored as a control program in a storage apparatus (not shown) of video decoding apparatus 200 (such as ROM or flash memory, for example) and executed by a CPU (Central Processing Unit) (not shown) of video decoding apparatus 200.

First, in step S101, decoding start processing is performed that starts video decoding on an image-by-image basis. Specifically, base layer input section 202 starts base layer input processing, and enhancement layer input section 211 starts enhancement layer input processing.

Next, in step S102, base layer input processing that inputs a base layer is performed. Specifically, base layer input section 202 fetches a base layer stream on a image-by-image basis, and outputs the stream to base layer decoding processing section 203.

Then, in step S103, base layer decoding processing that decodes the base layer is performed. Specifically, base layer decoding processing section 203 performs MPEG decoding processing such as Variable Length Decoding (VLD), de-quantization, inverse DCT, and motion compensation on the base layer stream input from base layer input section 202, generates a base layer decoded image, and outputs the generated base layer's decoded image to image addition section 214.

Meanwhile, in step S104, enhancement layer input processing that inputs an enhancement layer is performed. Specifically, enhancement layer input section 211 outputs an enhancement layer stream to enhancement layer decoding processing section 212.

Then, in step S105, bit plane VLD processing that executes VLD processing on an individual bit plane basis is performed, and shift value decoding processing that decodes the shift value for each macro block is performed. Specifically, enhancement layer decoding processing section 212 performs variable-length decoding (VLD) processing on an enhancement layer bit stream input from enhancement layer input section 211, calculates DCT coefficients of whole image and stepwise shift map of whole image that shows shift values for each macro block, and outputs the calculation results to filter parameter calculation section 213.

Then, in step S106, enhancement layer decoding processing that decodes the enhancement layer is performed. Specifically, enhancement layer decoding processing section 212 performs a bit-shift operation towards the lower bit direction for each macro block in accordance with the shift value indicated by the stepwise shift map on the DCT coefficient calculated in step S105, executes inverse DCT processing on the bit-shifted DCT coefficient and generates an enhancement layer's decoded image, and outputs the generated enhancement layer's decoded image to image addition section 214.

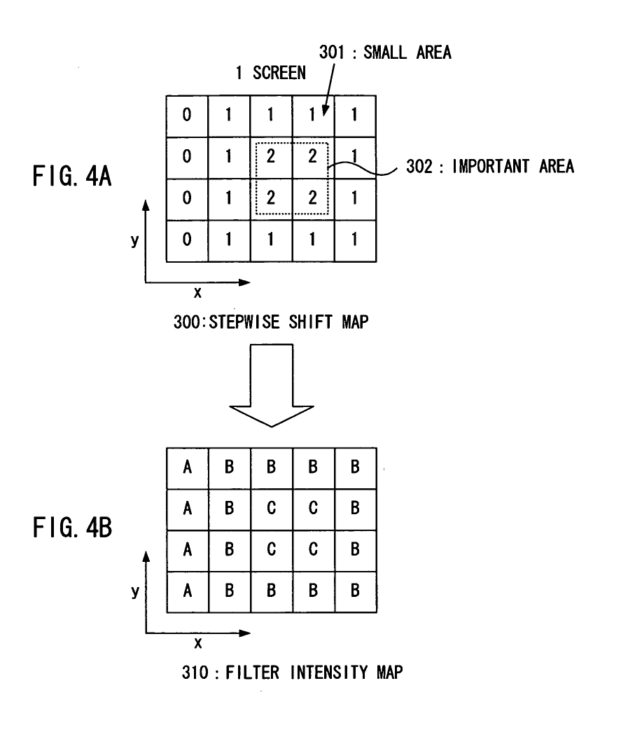

Meanwhile, in step S107, filter parameter calculation processing is performed based on the stepwise shift map calculated in step S105. Specifically, a filter parameter is calculated for the shift value set for each small area 301 in the stepwise shift map shown in FIG. 4A.

Stepwise shift map 300 in FIG. 4A is an example of a map that has a shift value for each small area 301 within one image indicated by an x-axis and y-axis. The largest shift value “2” is set for the group of small areas containing important area 302, and shift values become stepwise smaller in the peripheral area, with values of “1” and “0” being set.

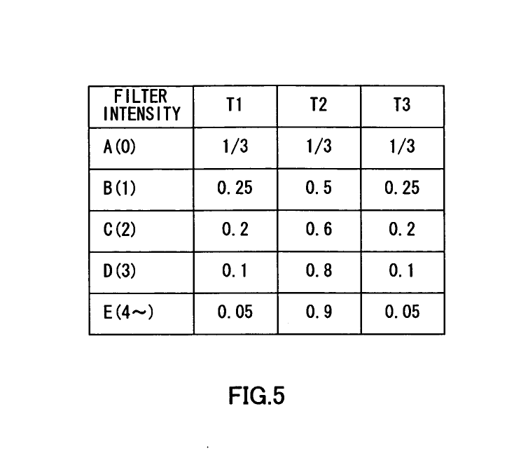

FIG. 5 is a drawing showing an example of a table in which filter intensities A (0), B (1), C (2), D (3), and E (4 and up), and filter parameters T1 through T3 are set. Values (0) through (4 and up) attached to these filter intensities A through E correspond to small areas 301 in FIG. 4A, and the result of applying filter intensities A through C based on this correspondence is filter intensity map 310 in FIG. 4B.

Filter parameter calculation section 213 then outputs the filter intensity applied to the shift value of each small area 301 in stepwise shift map 300 to post-filter processing section 215 as a filter parameter.

Then, in step S108, image addition processing is performed whereby a base layer decoded image and enhancement layer decoded image are added. Specifically, image addition section 214 adds a base layer decoded image input from base layer decoding processing section 203 and an enhancement layer decoded image input from enhancement layer decoding processing section 212 on a pixel-by-pixel basis and generates a reconstructed image, and outputs the generated reconstructed image to post-filter processing section 215.

Then, in step S109, post-filter processing is performed on the reconstructed image. Specifically, post-filter processing section 215 calculates, for the reconstructed image input from image addition section 214, pixel values after post-filter processing of each small area 301 for each small area by means of the filter parameters (filter intensities) input from filter parameter calculation section 213, using Equation (1) below.

X′(i,j)=T1*X(i−1,j)+T2*X(i,j)+T3*X(i+1,j) Eq.(1)

Where:

X(i,j): Pixel value of coordinates (i,j)

X′ (i,j): Pixel value after post-filter processing of coordinates (i,j)

TN: Filter parameter N (where N is an integer)

That is to say, filter parameters T1 through T3 corresponding to filter intensities A through C input for each small area are read from the table in FIG. 5, pixel values after post-filter processing of each small area are calculated by substitution in Equation (1), and a reconstructed image in which post-filter processing has been executed for each small area is output to reconstructed image output section 220.

Equation (1) is one example of a way of post-filter processing, and the way of post-filter processing is not limited to this. It is also possible to apply a method whereby filtering is performed in the Y-axis direction, the XY-axis directions, or a diagonal direction, and the number of filter parameters (T1, T2, T3) is not limited to three.

Reconstructed image output section 220 then outputs externally the reconstructed image after post-filter processing input from post-filter processing section 215.

Then, in step S110, termination determination processing is performed. Specifically, it is determined whether or not base layer stream input has stopped in base layer input section 202. If the result of this determination is that base layer stream input has stopped in base layer input section 202 (S110: YES), termination of decoding is determined, and the series of decoding processing operations is terminated, but if base layer stream input has not stopped in base layer input section 202 (S110: NO), the processing flow returns to step S101. That is to say, the series of processing operations in step S101 through step S109 is repeated until base layer stream input stops in base layer input section 202.

Thus, according to this embodiment, in video decoding apparatus 200 filter parameters that control the noise elimination intensity of post-filter processing section 215 are calculated based on the shift value of each small area set in a stepwise shift map in which the shift value decreases stepwise from an important area to the peripheral area within a screen in video coding apparatus 100, and post-filter processing of a decoded reconstructed image is performed by applying the calculated filter parameters in post-filter processing section 215, so that a filter parameter with a low noise elimination intensity can be set for an important area whose shift value is large, a filter parameter with a high noise elimination intensity can be set for a peripheral area whose shift value is small, peripheral area noise can be eliminated while maintaining sharp image quality of the important area, and the subjective image quality of an overall screen can be improved.

In this embodiment, the MPEG scheme is used for base layer coding and decoding, and the MPEG-4 FGS scheme is used for enhancement layer coding and decoding, but the present invention is not limited to this, and as long as the scheme uses bit plane coding, it is also possible to use other coding and decoding schemes, such as WAVELET coding of which JPEG2000 is a representative example.

(Embodiment 2)

In this embodiment, a video decoding apparatus is described to which is applied a moving image decoding scheme whereby a filter parameter that controls the noise elimination intensity of a post-filter is calculated based on a shift value set when performing coding on an individual small area basis and a received bit amount for each of these small areas, a filter parameter used when performing post-filter processing of a decoded image on an individual small area basis can be controlled adaptively, and the subjective image quality of an overall screen can be improved.

In Embodiment 2, a coded image resulting from coding the inside of a screen with shift values set on an individual small area basis by means of a stepwise shift map generated from important area information in video coding apparatus 100 shown in FIG. 1 is made subject to decoding processing.

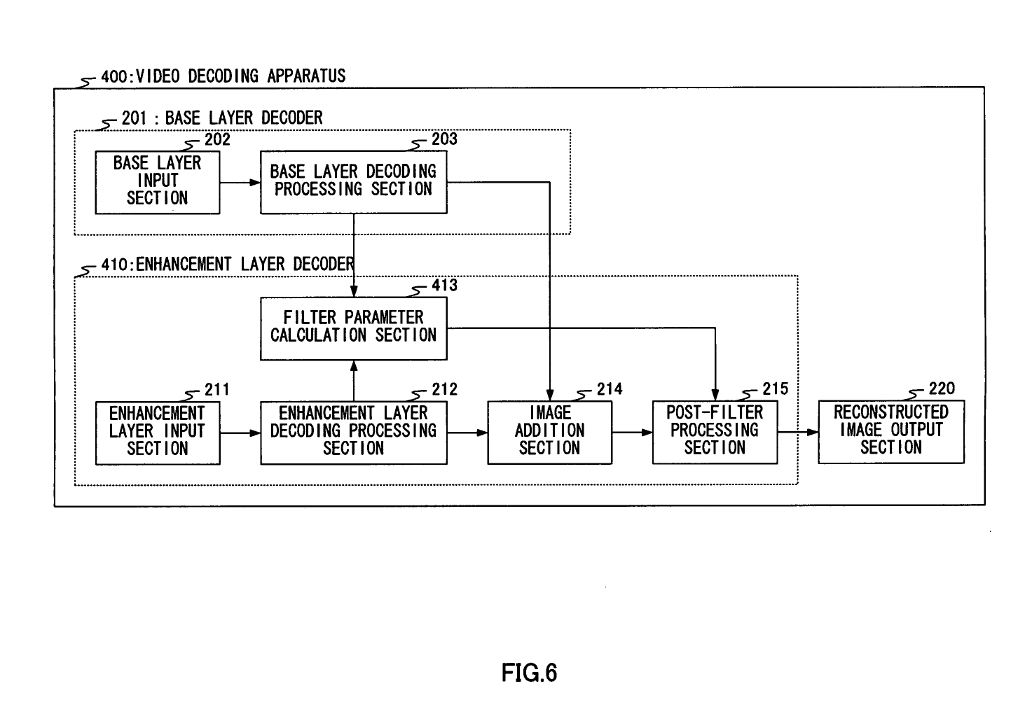

FIG. 6 is a block diagram showing the configuration of a video decoding apparatus to which a moving image decoding scheme according to Embodiment 2 of the present invention is applied. This video decoding apparatus 400 has a similar basic configuration to video coding apparatus 100 shown in FIG. 2, and therefore parts in FIG. 6 identical to those in FIG. 2 a reassigned the same reference codes as in FIG. 2, and detailed descriptions thereof are omitted.

A feature of this embodiment is that a filter parameter calculation section 413 in an enhancement layer decoder 410 calculates a filter parameter that controls the noise elimination intensity of post-filter processing section 215 based on a shift value for each small area of an enhancement layer decoded image and a received bit quantity proportion for each small area of a base layer decoded image.

Filter parameter calculation section 413 calculates a characteristic quantity for each small area from the received bit amount for each small area of a base layer decoded image input from base layer decoding processing section 203 as a proportion of received bit to the maximum value, and the shift value for each small area of an enhancement layer decoded image input from enhancement layer decoding processing section 212, calculates a filter parameter corresponding to this characteristic value, and outputs the filter parameter to post-filter processing section 215.

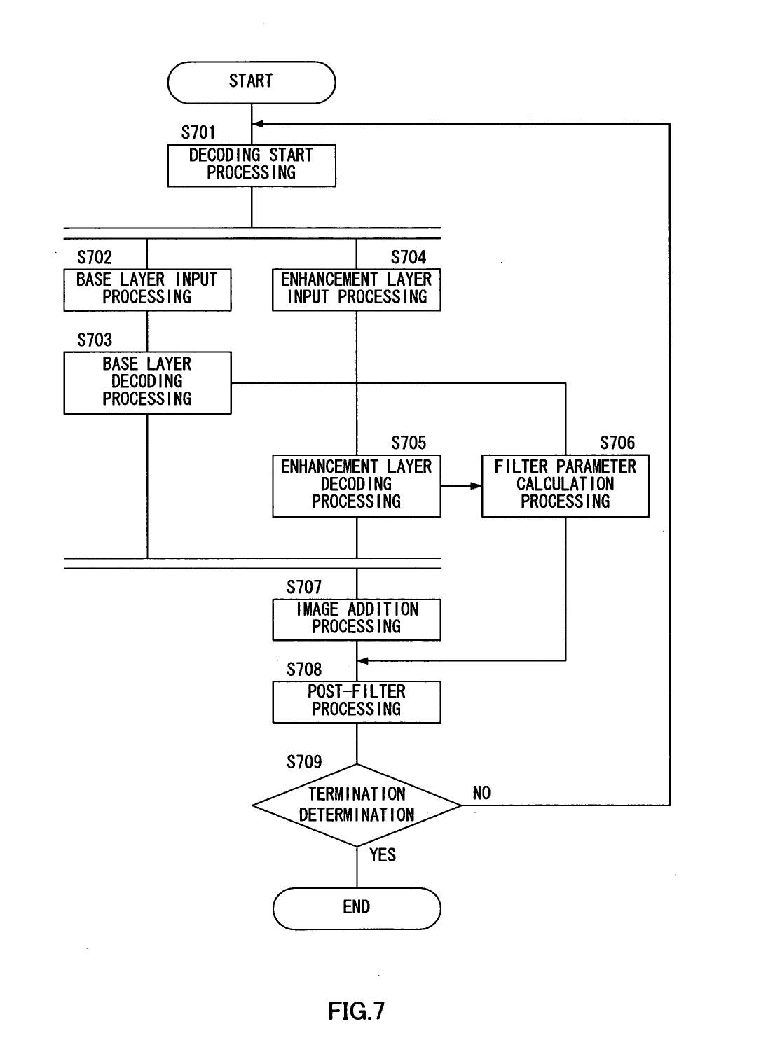

Next, the operation of video decoding apparatus 400 with the above configuration will be described, using the flowchart shown in FIG. 7. The flowchart in FIG. 7 is stored as a control program in a storage apparatus (not shown) of video decoding apparatus 400 (such as ROM or flash memory, for example) and executed by a CPU (not shown) of video decoding apparatus 400.

First, in step S701, decoding start processing is performed that starts video decoding on an image-by-image basis. Specifically, base layer input section 202 starts base layer input processing, and enhancement layer input section 211 starts enhancement layer input processing.

Next, in step S702, base layer input processing that inputs a base layer is performed. Specifically, base layer input section 202 fetches a base layer stream on a screen-by-screen basis, and outputs the stream to base layer decoding processing section 203.

Then, in step S703, base layer decoding processing that decodes the base layer is performed. Specifically, base layer decoding processing section 203 performs MPEG decoding processing by means of VLD, de-quantization, inverse DCT, motion compensation processing, and so forth, on the base layer stream input from base layer input section 202, generates a base layer's decoded image, and outputs the generated base layer's decoded image to image addition section 214.

Base layer decoding processing section 203 also calculates proportion Di of the received bit amount of each small area within one screen with respect to the maximum bit amount value in the screen, and outputs Di to filter parameter calculation section 413.

Meanwhile, in step S704, enhancement layer input processing that inputs an enhancement layer is performed. Specifically, enhancement layer input section 211 outputs an enhancement layer stream to enhancement layer decoding processing section 212.

Then, in step S705, enhancement layer decoding processing that decodes the enhancement layer is performed. Specifically, enhancement layer decoding processing section 212 performs variable-length decoding (VLD) processing on an enhancement layer bit stream input from enhancement layer input section 211, calculates an overall screen DCT coefficient and stepwise shift map, performs a bit-shift operation towards the lower bit direction for each macro block in accordance with the shift value indicated by the stepwise shift map on the calculated DCT coefficient, executes inverse DCT processing on the bit-shifted DCT coefficient and generates an enhancement layer decoded image, outputs the generated enhancement layer decoded image to image addition section 214, and also outputs the stepwise shift map to filter parameter calculation section 413.

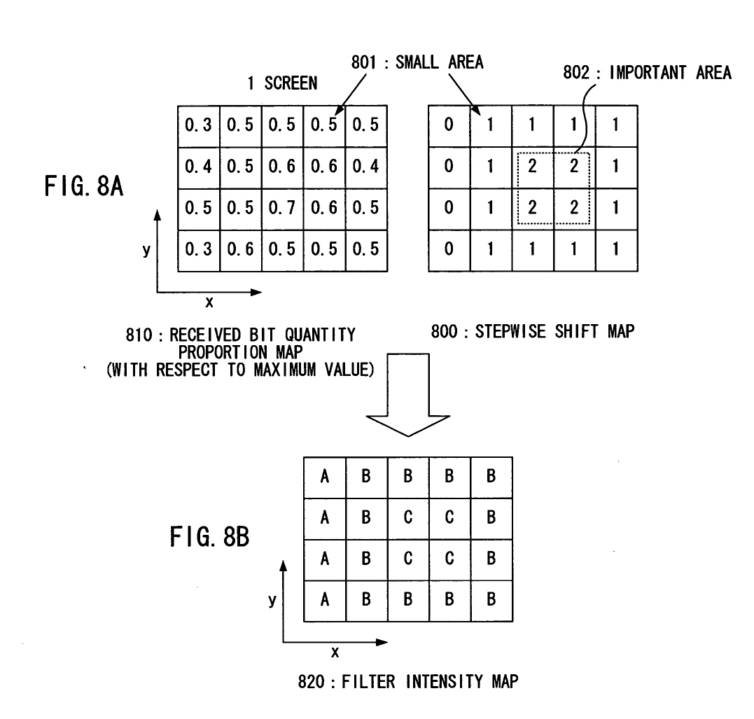

Meanwhile, in step S706, filter parameter calculation processing is performed based on the received bit amount as a proportion to the maximum value calculated in step S703 and the stepwise shift map calculated in step S705. Specifically, filter parameters are calculated by means of the following procedure using the shift value and received bit amount proportion set for each small area 801 in the stepwise shift map 800 and received bit amount proportion map 810 shown in FIG. 8A.

Stepwise shift map 800 in FIG. 4A is an example of a map that has a shift value for each small area 801 within one screen indicated by an x-axis and y-axis. The largest shift value “2” is set for the group of small areas containing important area 802, and shift values become gradually smaller in the peripheral area, with values of “1” and “0” being set.

Received bit amount proportion map 810 in FIG. 4A is a drawing showing examples of received bit amount for each small area 801, as proportions to the maximum value, within one screen indicated by an x-axis and y-axis.

Using Equation (2) below, filter parameter calculation section 413 then calculates characteristic quantity Nᵢ of each small area 801 based on the received bit quantity of each small area 801, as a proportion of the maximum value, in received bit amount proportion map 810, and the shift value of each small area 801 in stepwise shift map 800.

Nᵢ=Dᵢ*(Sᵢ/Sₘₐₓ) Eq. (2)

Where:

Nᵢ: Characteristic quantity of small area i

Dᵢ: Received bit quantity of small area i as proportion to maximum value

Sᵢ: Shift value of small area i

Sₘₐₓ: Maximum value of shift value

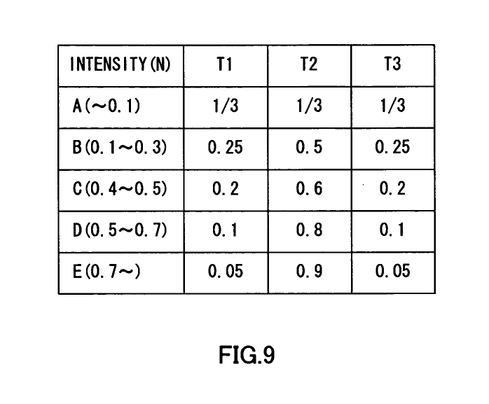

Based on calculated characteristic quantity Ni, filter parameter calculation section 413 then determines filter intensity N from the filter parameter table shown in FIG. 9.

FIG. 9 is a drawing showing an example of a table in which filter intensities A (up to 0.1), B (0.1 to 0.3), C (0.4 to 0.5), D (0.5 to 0.7), and E (0.7 and up), and filter parameters T1 through T3 are set. Values (up to 0.1) through (0.7 and up) attached to these filter intensities A through E are the values of characteristic quantity Nᵢ of each small area 801, and the result of applying filter intensities A through C based on this correspondence is filter intensity map 820 in FIG. 8B.

Then, in step S707, image addition processing is performed whereby a base layer decoded image and enhancement layer decoded image are added. Specifically, image addition section 214 adds a base layer decoded image input from base layer decoding processing section 203 and an enhancement layer decoded image input from enhancement layer decoding processing section 212 on a pixel-by-pixel basis and generates a reconstructed image, and outputs the generated reconstructed image to post-filter processing section 215.

Then, in step S708, post-filter processing is performed on the reconstructed image. Specifically, post-filter processing section 215 calculates, for the reconstructed image input from image addition section 214, pixel values after post-filter processing of each small area 801 for each small area by means of the filter parameters (filter intensities) input from filter parameter calculation section 413, using Equation (1) above.

Then, in step S709, termination determination processing is performed. Specifically, it is determined whether or not base layer stream input has stopped in base layer input section 202. If the result of this determination is that base layer stream input has stopped in base layer input section 202 (S709: YES), termination of decoding is determined, and the series of decoding processing operations is terminated, but if base layer stream input has not stopped in base layer input section 202 (S709: NO), the processing flow returns to step S701. That is to say, the series of processing operations in step S701 through step S708 is repeated until base layer stream input stops in base layer input section 202.

Thus, according to this embodiment, in video decoding apparatus 400 filter parameters that control the noise elimination intensity of post-filter processing section 215 are calculated by filter parameter calculation section 413 based on the shift value of each small area set in a stepwise shift map in which the shift value decreases stepwise from an important area to the peripheral area, and the received bit amount as a proportion to the maximum value, within a screen in video coding apparatus 100, and post-filter processing of a decoded reconstructed image is performed by applying the calculated filter parameters in post-filter processing section 215, so that a filter parameter with a low noise elimination intensity can be set for an important area whose shift value is large and received bit amount is large, a filter parameter with a high noise elimination intensity can be set for a peripheral area whose shift value is small and received bit amount is small, peripheral area noise can be eliminated while maintaining sharp image quality of the important area, and the subjective image quality of an overall screen can be improved.

In this embodiment, a video decoding apparatus is described to which is applied a moving image decoding scheme whereby a filter parameter that controls the noise elimination intensity of a post-filter is calculated based on a shift value set when performing coding on an individual small area basis and a received bit amount for each of these small areas, a filter parameter used when performing post-filter processing of a decoded image on an individual small area basis can be controlled adaptively, and the subjective image quality of an overall screen can be improved.

Furthermore, when the received bit rate is high, excessive filter application can be avoided, and when the received bit rate is low, efficient improvement of image quality can be achieved by using a stronger filter.

In this embodiment, the MPEG scheme is used for base layer coding and decoding, and the MPEG-4 FGS scheme is used for enhancement layer coding and decoding, but the present invention is not limited to this, and as long as the scheme uses bit plane coding, it is also possible to use other coding and decoding schemes, such as WAVELET coding of which JPEG2000 is a representative example. Also, in this embodiment, a filter parameter is calculated using a received bit amount as a proportion to the maximum value, but the present invention is not limited to this, and it is also possible to use another scheme as long as it is a scheme that uses bit amount proportions.

(Embodiment 3)

In this embodiment, a video decoding apparatus is described to which is applied a moving image decoding scheme whereby a filter parameter that controls the noise elimination intensity of a post-filter is calculated based on a shift value set when performing coding on an individual small area basis, a part for which the difference in noise elimination intensity is large with respect to a peripheral small area on an individual small area basis, a filter parameter used when performing post-filter processing of a decoded image on an individual small area basis can be controlled adaptively, and the subjective image quality of an overall screen can be improved.

In Embodiment 3, a coded image resulting from coding the inside of a screen with shift values set on an individual small area basis by means of a stepwise shift map generated from important area information in video coding apparatus 100 shown in FIG. 1 is made subject to decoding processing.

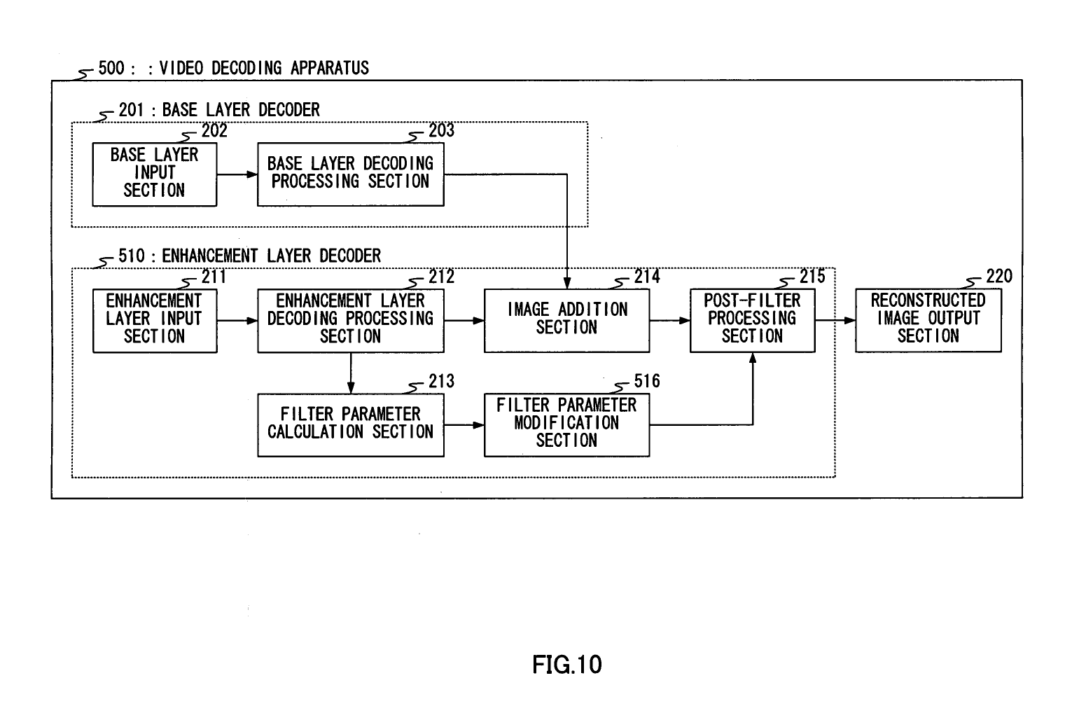

FIG. 10 is a block diagram showing the configuration of a video decoding apparatus to which a moving image decoding scheme according to Embodiment 3 of the present invention is applied. This video decoding apparatus 500 has a similar basic configuration to video coding apparatus 100 shown in FIG. 2, and therefore parts in FIG. 10 identical to those in FIG. 2 are assigned the same reference codes as in FIG. 2, and detailed descriptions thereof are omitted.

A filter parameter modification section 516 within an enhancement layer decoder 510 executes modification processing whereby the filter parameter level for each small area of an enhancement layer decoded image calculated by filter parameter calculation section 213 is corrected according to the filter parameter level of a peripheral area, and controls the noise elimination intensity of post-filter processing section 215.

Filter parameter modification section 516 executes modification processing whereby the filter parameter level for each small area of an enhancement layer decoded image calculated by filter parameter calculation section 213 is modified according to the filter parameter level of a peripheral area.

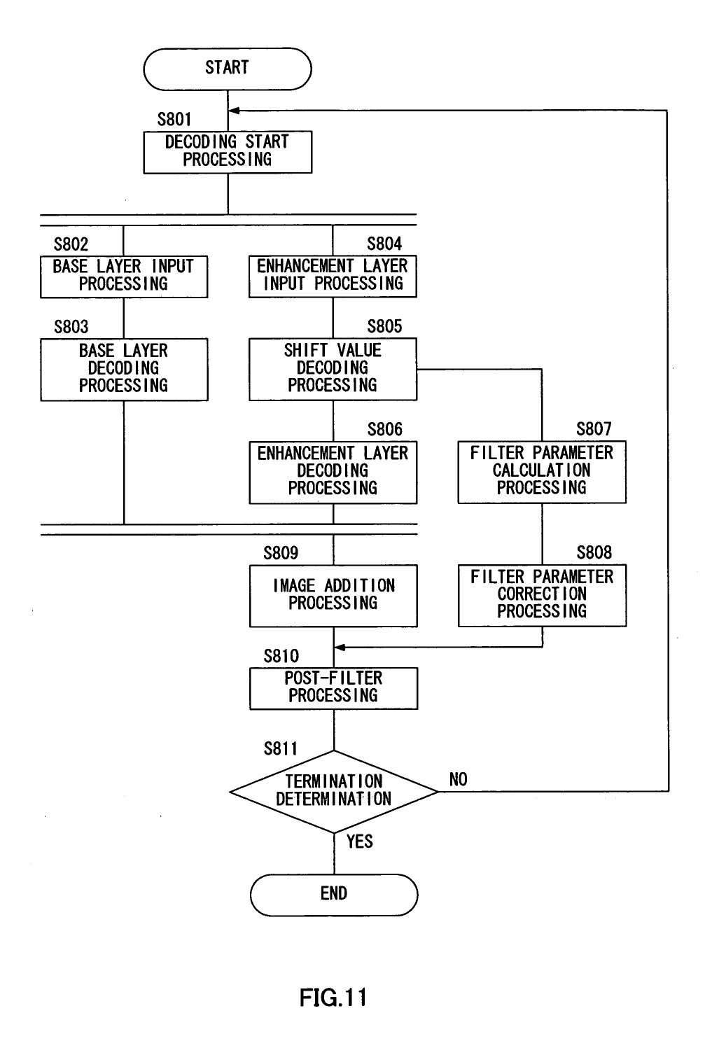

Next, the operation of video decoding apparatus 500 with the above configuration will be described, using the flowchart shown in FIG. 11. The flowchart in FIG. 11 is stored as a control program in a storage apparatus (not shown) of video decoding apparatus 500 (such as ROM or flash memory, for example) and executed by a CPU (not shown) of video decoding apparatus 500.

First, in step S801, decoding start processing is performed that starts video decoding on an image-by-image basis. Specifically, base layer input section 202 starts base layer input processing, and enhancement layer input section 211 starts enhancement layer input processing.

Next, in step S802, base layer input processing that inputs a base layer is performed. Specifically, base layer input section 202 fetches a base layer stream on a screen-by-screen basis, and outputs the stream to base layer decoding processing section 203.

Then, in step S803, base layer decoding processing that decodes the base layer is performed. Specifically, base layer decoding processing section 203 performs MPEG decoding processing by means of VLD, de-quantization, inverse DCT, motion compensation processing, and so forth, on the base layer stream input from base layer input section 202, generates a base layer decoded image, and outputs the generated base layer decoded image to image addition section 214.

Meanwhile, in step S804, enhancement layer input processing that inputs an enhancement layer is performed. Specifically, enhancement layer input section 211 outputs an enhancement layer stream to enhancement layer decoding processing section 212.

Then, in step S805, bit plane VLD processing that executes VLD processing on an individual bit plane basis is performed, and shift value decoding processing that decodes the shift value is performed. Specifically, enhancement layer decoding processing section 212 performs variable-length decoding (VLD) processing on an enhancement layer bit stream input from enhancement layer input section 211, calculates an overall screen DCT coefficient and stepwise shift map, and outputs the calculation results to filter parameter calculation section 213.

Then, in step S806, enhancement layer decoding processing that decodes the enhancement layer is performed. Specifically, enhancement layer decoding processing section 212 performs a bit-shift in the low-order bit direction for each macro block in accordance with the shift value indicated by the stepwise shift map on the DCT coefficient calculated in step S805, executes inverse DCT processing on the bit-shifted DCT coefficient and generates an enhancement layer's decoded image, and outputs the generated enhancement layer's decoded image to image addition section 214.

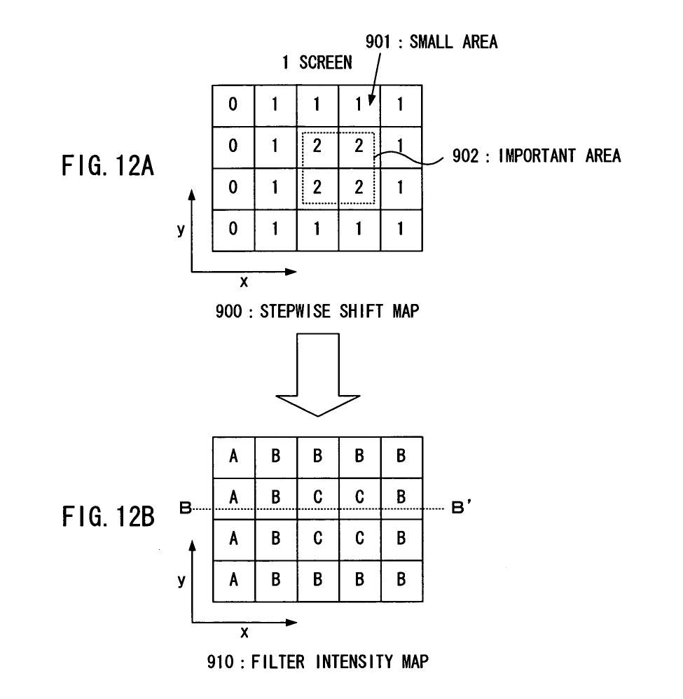

Meanwhile, in step S807, filter parameter calculation processing is performed based on the stepwise shift map calculated in step S805. Specifically, a filter parameter is calculated for the shift value set for each small area 901 in stepwise shift map 900 shown in FIG. 12A.

Stepwise shift map 900 in FIG. 9A is an example of a map that has a shift value for each small area 901 within one screen indicated by an x-axis and y-axis. The largest shift value “2” is set for the group of small areas containing important area 902, and shift values become gradually smaller in the peripheral area, with values of “1” and “0” being set.

The result of applying filter intensities A through C based on the correspondence between filter intensities A (0), B (1), C (2), D (3), and E (4 and up) and filter parameters T1 through T3 set in the filter intensity table in FIG. 5 to stepwise shift map 900 in FIG. 12A is filter intensity map 910 in FIG. 12B.

Filter parameter calculation section 213 then outputs the filter intensity applied to the shift value of each small area 901 in stepwise shift map 900 to filter parameter modification section 516 as a filter parameter.

Then, in step S808, modification processing is executed whereby the filter parameter level of each small area 901 calculated in step S807 is modified according to filter parameter levels of peripheral areas. Specifically, the filter parameter level is modified for each small area 901 in filter intensity map 910 shown in FIG. 12B.

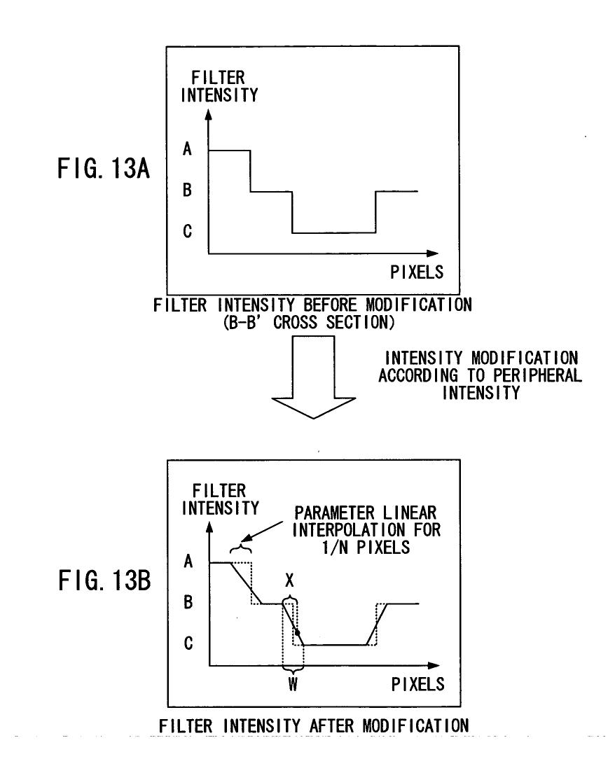

The filter intensity modification processing executed by filter parameter modification section 516 will now be described in detail with reference to FIG. 13.

FIG. 13A is a drawing showing a cross section when line section B-B′ is cut from front to back in the drawing in filter intensity map 910 shown in FIG. 12B, and indicates the differences in level of filter intensities A, B, and C.

In this case, it is shown that differences in level arise stepwise between filter intensities A through C, and if the noise elimination intensity of post-filter processing section 215 is controlled by means of these filter parameters, this will also be reflected in the filter processing results for each small area, and there is a possibility of the occurrence of image quality disparity around boundary areas close to areas for which the filter intensity varies greatly within one screen.

Thus, linear interpolation processing is executed to reduce differences in the filter parameter level between small areas, as shown by filter intensities after modification in FIG. 13B. This linear interpolation processing is performed using mathematical expressions (3) and (4) below.

T2′(x)=T2+(T2ₙ−T2)*x/W Eq. (3)

T1′(x)=T3′(x)=(1−T2′(x))/2 Eq. (4)

Where:

TN: Filter parameter N before modification

TN′: Filter parameter N after modification

TNₙ: Nearby filter parameter N

W: Number of pixels in interpolation section

x: Number of pixels from interpolation starting point

N: Integer

Filter parameter modification section 516 then outputs the results of correcting small area filter parameters using above mathematical expressions (3) and (4) to post-filter processing section 215.

Then, in step S809, image addition processing is performed whereby a base layer's decoded image and enhancement layer's decoded image are added. Specifically, image addition section 214 adds a base layer's decoded image input from base layer decoding processing section 203 and an enhancement layer's decoded image input from enhancement layer decoding processing section 212 on a pixel-by-pixel basis and generates a reconstructed image, and outputs the generated reconstructed image to post-filter processing section 215.

Then, in step S810, post-filter processing is performed on the reconstructed image. Specifically, post-filter processing section 215 executes post-filter processing for each small area by means of the corrected filter parameters input from filter parameter modification section 516 on the reconstructed image input from image addition section 214.

Reconstructed image output section 220 then outputs externally the reconstructed image after post-filter processing input from post-filter processing section 215.

Then, in step S811, termination determination processing is performed. Specifically, it is determined whether or not base layer stream input has stopped in base layer input section 202. If the result of this determination is that base layer stream input has stopped in base layer input section 202 (S811: YES), termination of decoding is determined, and the series of decoding processing operations is terminated, but if base layer stream input has not stopped in base layer input section 202 (S811: NO), the processing flow returns to step S801. That is to say, the series of processing operations in step S801 through step S810 is repeated until base layer stream input stops in base layer input section 202.

Thus, according to this embodiment, in video decoding apparatus 500 filter parameters that control the noise elimination intensity of post-filter processing section 215 are calculated based on the shift value of each small area set in a stepwise shift map in which the shift value decreases stepwise from an important area to the peripheral area within a screen in video coding apparatus 100, and moreover filter parameters are corrected by performing linear interpolation processing of the filter intensity of each small area using filter intensities of surrounding small areas, and post-filter processing of a reconstructed image is performed by applying the modified filter parameters in post-filter processing section 215, so that a filter parameter with a low noise elimination intensity can be set for an important area whose shift value is large, the noise elimination intensity can be modified to a larger value for a boundary pixel near an area whose peripheral filter intensities are high, the noise elimination intensity can be modified to a smaller value for a boundary pixel near an area whose peripheral filter intensities are low, peripheral area noise can be eliminated while maintaining sharp image quality of the important area, a smooth image can be generated by reducing image quality disparity at an image boundary, and the subjective image quality of an overall screen can be improved.

In this embodiment, the MPEG scheme is used for base layer coding and decoding., and the MPEG-4 FGS scheme is used for enhancement layer coding and decoding, but the present invention is not limited to this, and as long as the scheme uses bit plane coding, it is also possible to use other coding and decoding schemes.

Also, in above Embodiment 3, a case has been described in which linear interpolation is performed using a difference from peripheral area filter parameters in interpolation, but another interpolation method may also be applied, the essential point being that the interpolation method should be able to suppress disparity of area boundary filter intensities.

(Embodiment 4)

In this embodiment, a video decoding apparatus is described to which is applied a moving image decoding scheme whereby a filter parameter that controls the noise elimination intensity of a post-filter is calculated based on a shift value set when performing coding on an individual small area basis, that calculated filter parameter is temporarily stored and the filter parameter calculated next is corrected by means of a stored past filter parameter, a filter parameter used when performing post-filter processing of a decoded image on an individual small area basis can be controlled adaptively, and the subjective image quality of an overall screen can be improved.

In Embodiment 4, a coded image resulting from coding the inside of a screen with shift values set on an individual small area basis by means of a stepwise shift map generated from important area information in video coding apparatus 100 shown in FIG. 1 is made subject to decoding processing.

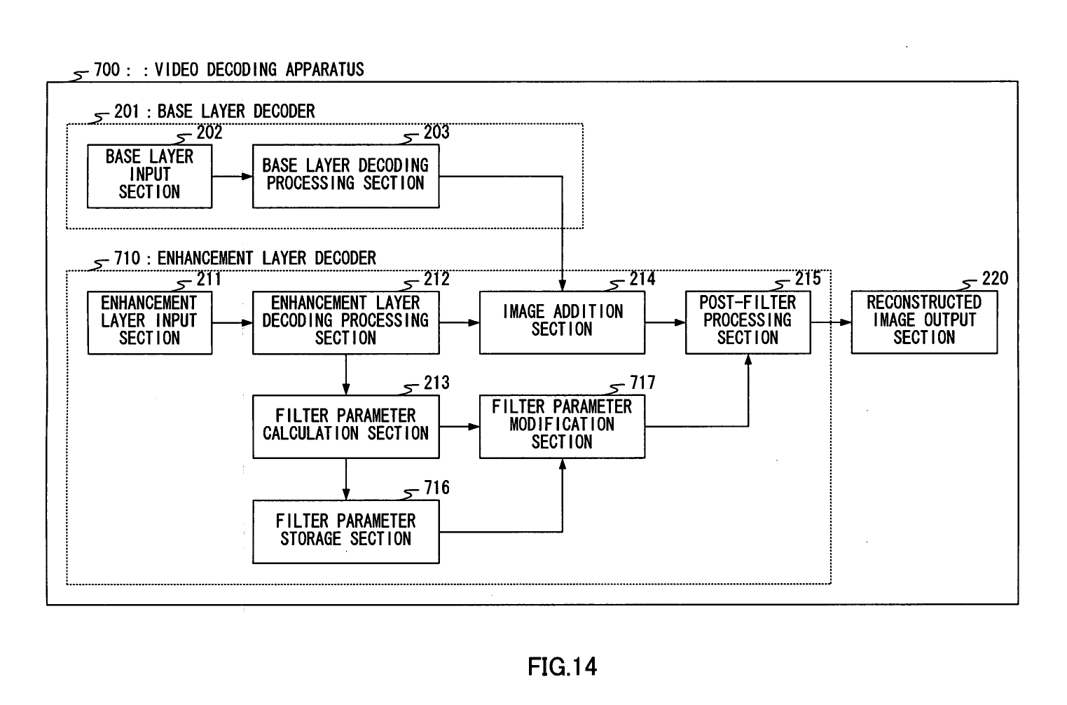

FIG. 14 is a block diagram showing the configuration of a video decoding apparatus to which a moving image decoding scheme according to Embodiment 4 of the present invention is applied. This video decoding apparatus 700 has a similar basic configuration to video decoding apparatus 100 shown in FIG. 2, and therefore parts in FIG. 14 identical to those in FIG. 2 are assigned the same reference codes as in FIG. 2, and detailed descriptions thereof are omitted.

A filter parameter storage section 716 within an enhancement layer decoder 710 stores a filter parameter calculated by filter parameter calculation section 213, and a filter parameter modification section 717 executes modification processing whereby a filter parameter calculated by filter parameter calculation section 213 is corrected by means of a past filter parameter stored in filter parameter storage section 716.

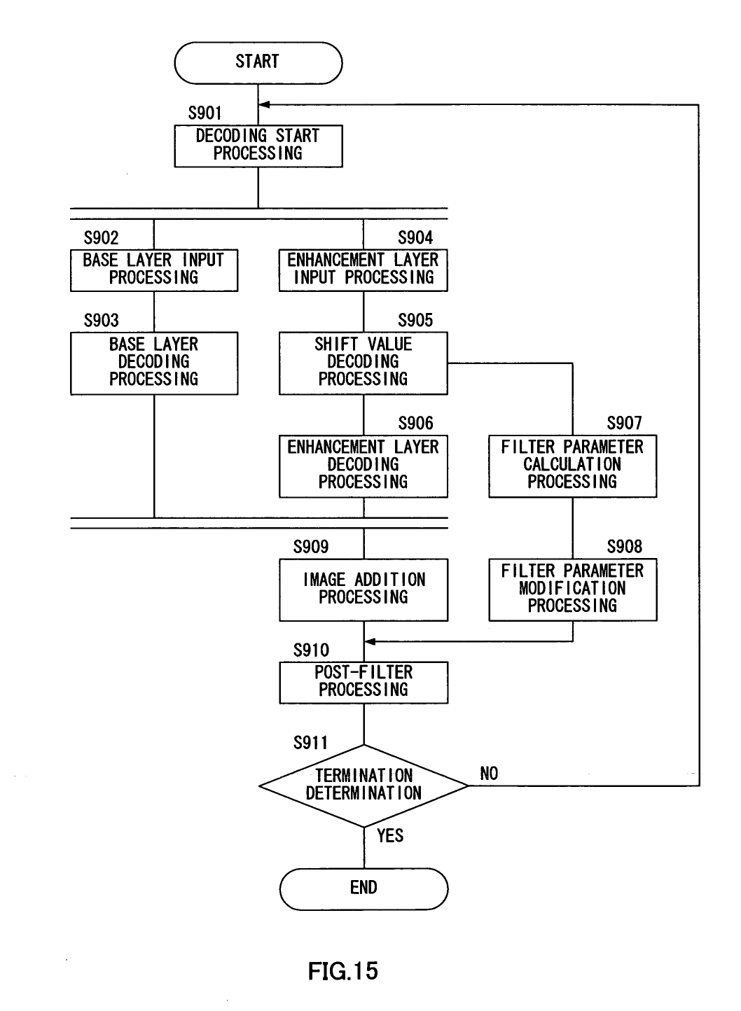

Next, the operation of video decoding apparatus 700 with the above configuration will be described, using the flowchart shown in FIG. 15. The flowchart in FIG. 15 is stored as a control program in a storage apparatus (not shown) of video decoding apparatus 700 (such as ROM or flash memory, for example) and executed by a CPU (not shown) of video decoding apparatus 700.

First, in step S901, decoding start processing is performed that starts video decoding on an image-by-image basis. Specifically, base layer input section 202 starts base layer input processing, and enhancement layer input section 211 starts enhancement layer input processing.

Next, in step S902, base layer input processing that inputs a base layer is performed. Specifically, base layer input section 202 fetches a base layer stream on a screen-by-screen basis, and outputs the stream to base layer decoding processing section 203.

Then, in step S903, base layer decoding processing that decodes the base layer is performed. Specifically, base layer decoding processing section 203 performs MPEG decoding processing by means of VLD, de-quantization, inverse DCT, motion compensation processing, and so forth, on the base layer stream input from base layer input section 202, generates a base layer decoded image, and outputs the generated base layer decoded image to image addition section 214.

Meanwhile, in step S904, enhancement layer input processing that inputs an enhancement layer is performed. Specifically, enhancement layer input section 211 outputs an enhancement layer stream to enhancement layer decoding processing section 212.

Then, in step S905, bit plane VLD processing that executes VLD processing on an individual bit plane basis is performed, and shift value decoding processing that decodes the shift value is performed. Specifically, enhancement layer decoding processing section 212 performs variable-length decoding (VLD) processing on an enhancement layer bit stream input from enhancement layer input section 211, calculates an overall screen DCT coefficient and stepwise shift map, and outputs the calculation results to filter parameter calculation section 213.

Then, in step S906, enhancement layer decoding processing that decodes the enhancement layer is performed. Specifically, enhancement layer decoding processing section 212 performs a bit-shift operation towards lower bit direction for each macro block in accordance with the shift value indicated by the stepwise shift map on the DCT coefficient calculated in step S905, executes inverse DCT processing on the bit-shifted DCT coefficient and generates an enhancement layer's decoded image, and outputs the generated enhancement layer's decoded image to image addition section 214.

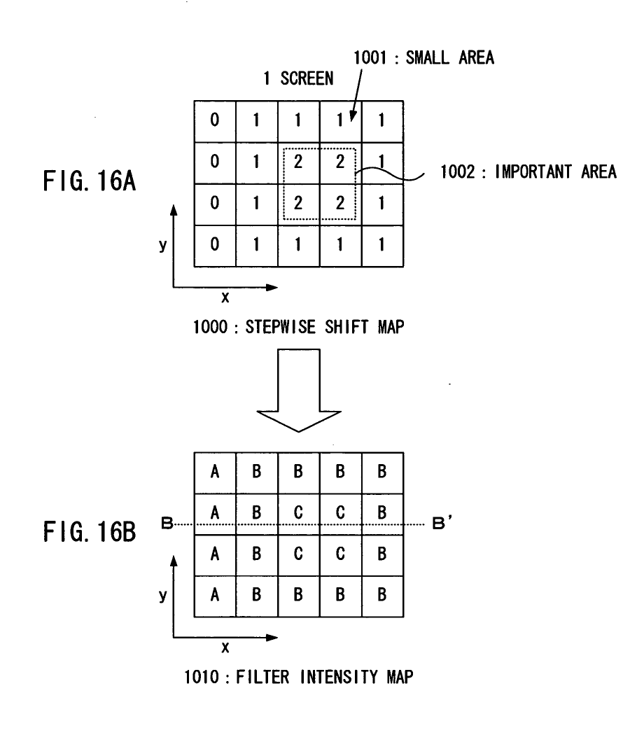

Meanwhile, in step S907, filter parameter calculation processing is performed based on the stepwise shift map calculated in step S905. Specifically, a filter parameter is calculated for the shift value set for each small area 1001 in stepwise shift map 1000 shown in FIG. 16A.

Stepwise shift map 1000 in FIG. 16A is an example of a map that has a shift value for each small area 1001 within one screen indicated by an x-axis and y-axis. The largest shift value “2” is set for the group of small areas containing important area 1002, and shift values become gradually smaller in the peripheral area, with values of “1” and “0” being set.

The result of applying filter intensities A through C based on the correspondence between filter intensities A (0), B (1), C (2), D (3), and E (4 and up) and filter parameters T1 through T3 set in the filter intensity table in FIG. 5 to stepwise shift map 1000 in FIG. 16A is filter intensity map 1010 in FIG. 16B.

Filter parameter calculation section 213 then outputs the filter intensity applied to the shift value of each small area 1001 in stepwise shift map 1000 to filter parameter modification section 717 as a filter parameter, and also outputs this filter parameter to filter parameter storage section 716, where it is stored.

At this time, the first filter parameter calculated at the time of the first decoding processing is stored in filter parameter storage section 716, and is output to filter parameter modification section 717 at the time of the next decoding processing.

Thus, at the time of the first decoding processing, a previous filter parameter has not been not stored in filter parameter storage section 716, and therefore the filter parameter calculated first is output to post-filter processing section 215 without being modified by filter parameter modification section 717.

Then, in step S908, modification processing is executed whereby the filter parameter level of each small area 1001 calculated in step S907 is modified by means of the previous filter parameter stored in filter parameter storage section 716. Specifically, the filter parameter level calculated for each small area 1001 is modified in filter intensity map 1010 shown in FIG. 16B by means of the previous filter parameter stored in filter parameter storage section 716.

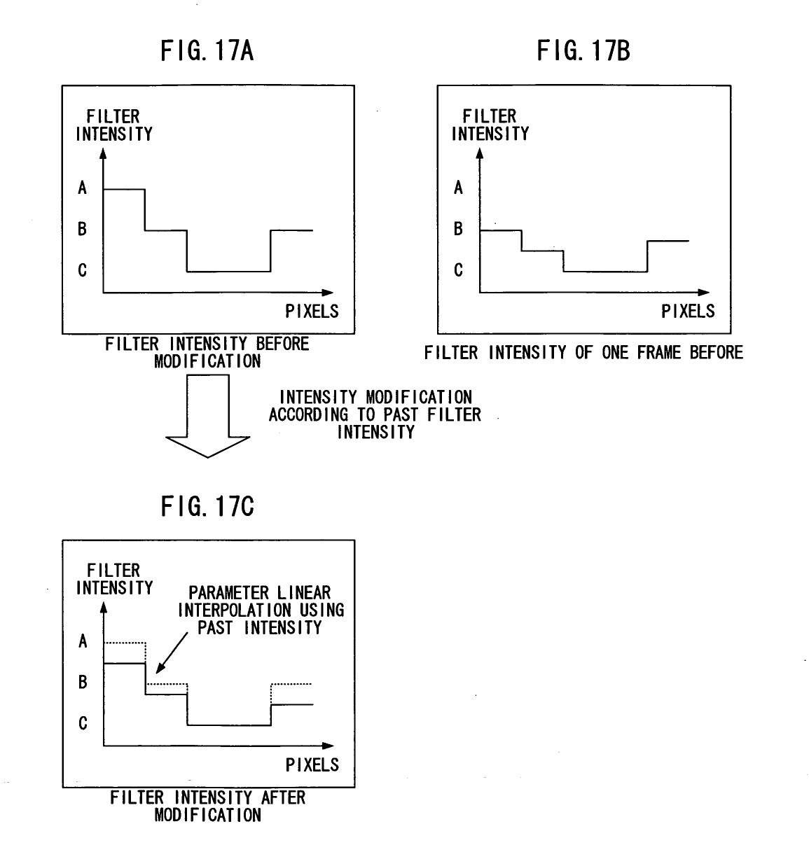

The filter intensity modification processing executed by filter parameter modification section 717 will now be described in detail with reference to FIG. 17.

FIG. 17A is a drawing showing a cross section when line section B-B′ is cut from front to back in the drawing in filter intensity map 1010 shown in FIG. 16B, and indicates the differences in level of filter intensities A, B, and C. FIG. 17B indicates similar differences in level of filter intensities B and C of one frame before stored the previous time.

In this case, it is shown that differences in level between filter intensities A through C are large, and if the noise elimination intensity of post-filter processing section 215 is controlled by means of these filter parameters, this will also be reflected in the filter processing results for each small area, and there is a possibility of major image quality disparity occurring temporally in areas for which the filter intensity varies greatly compared with a past decoded image.

Thus, linear interpolation processing is executed using the filter parameters of one frame before in FIG. 17B to reduce differences in the filter parameter level between temporally successive two small areas, as shown by filter intensities after modification in FIG. 17C. This linear interpolation processing is performed using mathematical expressions (5) and (6) below.

T2′(x)=α*T2ᵢ+(1−α)*T2 Eq. (5)

T1′(x)=T3′(x)=(1−T2′(x))/2 Eq. (6)

Where:

TN: Filter parameter N before modification

TN′: Filter parameter N after modification

TNᵢ: Filter parameter N of one frame before

α: Past filter intensity contribution ratio (0.0 to 1.0)

x: Small area number

N: Integer

Filter parameter modification section 717 then outputs the results of correcting small area filter parameters using above mathematical expressions (5) and (6) to post-filter processing section 215.

Then, in step S909, image addition processing is performed whereby a base layer's decoded image and enhancement layer's decoded image are added. Specifically, image addition section 214 adds a base layer's decoded image input from base layer decoding processing section 203 and an enhancement layer's decoded image input from enhancement layer decoding processing section 212 on a pixel-by-pixel basis and generates a reconstructed image, and outputs the generated reconstructed image to post-filter processing section 215.

Then, in step S910, post-filter processing is performed on the reconstructed image. Specifically, post-filter processing section 215 executes post-filter processing for each small area by means of the modified filter parameters input from filter parameter modification section 717 on the reconstructed image input from image addition section 214.

Reconstructed image output section 220 then outputs externally the reconstructed image after post-filter processing input from post-filter processing section 215.

Then, in step S911, termination determination processing is performed. Specifically, it is determined whether or not base layer stream input has stopped in base layer input section 202. If the result of this determination is that base layer stream input has stopped in base layer input section 202 (S911: YES), termination of decoding is determined, and the series of decoding processing operations is terminated, but if base layer stream input has not stopped in base layer input section 202 (S911: NO), the processing flow returns to step S901. That is to say, the series of processing operations in step S901 through step S910 is repeated until base layer stream input stops in base layer input section 202.

Thus, according to this embodiment, in video decoding apparatus 700 filter parameters that control the noise elimination intensity of post-filter processing section 215 are calculated based on the shift value of each small area set in a stepwise shift map in which the shift value decreases stepwise from an important area to the peripheral area within a screen in video coding apparatus 100, and moreover filter parameters are modified by performing temporally linear interpolation processing of the filter intensity of each small area using past filter intensities, and post-filter processing of a decoded reconstructed image is performed by applying the corrected filter parameters in post-filter processing section 215, so that filter intensity fluctuations between successive frames can be prevented and temporally smooth video can be provided, peripheral area noise can be eliminated while maintaining sharp image quality of the important area, and the subjective image quality of an overall screen can be improved.

In this embodiment, the MPEG scheme is used for base layer coding and decoding, and the MPEG-4 FGS scheme is used for enhancement layer coding and decoding, but the present invention is not limited to this, and as long as the scheme uses bit plane coding, it is also possible to use other coding and decoding schemes, such as WAVELET coding of which JPEG2000 is a representative example.

Also, in above Embodiment 4, a case has been described in which linear interpolation is performed using filter parameters of the previous frame in interpolation, but another interpolation method may also be applied, the essential point being that the interpolation method should be able to suppress filter intensity fluctuations between frames.

As described above, according to the present invention it is possible to control post-filter filter parameters adaptively based on characteristic quantities of priority-coded data, and to improve the subjective image quality of an overall screen.

The present invention is not limited to the above-described embodiments, and various variations and modifications may be possible without departing from the scope of the present invention.

This application is based on Japanese Patent Application No. 2003-137838 filed on May 15, 2003, entire content of which is expressly incorporated by reference herein.

What is claimed is:

1. A moving image decoding apparatus that decodes priority-coded data in which a moving image is priority-coded on an area-by-area basis, comprising:
a calculation section that calculates a filter parameter of a post-filter that processes a noise component based on a characteristic quantity set for said priority-coded data; and
a post-filter processing section that applies said filter parameter to a post-filter and processes a noise component of decoded data of said priority-coded data.

2. The moving image decoding apparatus according to claim 1, wherein:
said characteristic quantity is at least one of a bit-shift value set when performing said priority coding on an area-by-area basis, or a proportion of per-area said priority-coded data with respect to a total received bit amount; and
said calculation section calculates a post-filter filter parameter on an area-by-area basis based on said characteristic quantity.

3. The moving image decoding apparatus according to claim 2, wherein:
said calculation section compares said characteristic quantity and a predetermined threshold value, and calculates a noise elimination intensity on an area-by-area basis as said filter parameter; and
said post-filter processing section applies said noise elimination intensity to a post-filter and processes a noise component of decoded data of said priority-coded data.

4. The moving image decoding apparatus according to claim 3, wherein said calculation section increases a noise elimination intensity when said characteristic quantity is smaller than said threshold value, and decreases a noise elimination intensity when said characteristic quantity is greater than said threshold value.

5. The moving image decoding apparatus according to claim 1, wherein:
said calculation section uses a noise elimination intensity as a filter parameter calculated based on said per-area characteristic quantity and calculates a per-area difference of said filter parameter, and calculates a modification value that modifies said noise elimination intensity on a pixel-by-pixel basis using said difference; and
said post-filter processing section modifies a post-filter noise elimination intensity based on said modification value, and applies a noise elimination intensity after said modification to a post-filter and processes said noise component of decoded data of said priority-coded data.

6. The moving image decoding apparatus according to claim 1, wherein:
said calculation section calculates said post-filter noise elimination intensity on an area-by-area basis, and also stores a noise elimination intensity each time that calculation is performed and corrects a calculated noise elimination intensity using a stored past noise elimination intensity; and
said post-filter processing section sets a post-filter noise elimination intensity based on said corrected noise elimination intensity and processes said noise component of decoded data of said priority-coded data.

7. A moving image decoding method that decodes priority-coded data in which a moving image is priority-coded on an area-by-area basis, comprising:
a calculation step of calculating a filter parameter of a post-filter that processes a noise component based on a characteristic quantity set for said priority-coded data; and
a post-filter processing step of applying said filter parameter to a post-filter and processing a noise component of decoded data of said priority-coded data.

8. The moving image decoding method according to claim 7, wherein:
said characteristic quantity is at least one of a bit-shift value set when performing said priority coding on an area-by-area basis, or a proportion of per-area said priority-coded data with respect to a total received bit quantity; and
said calculation step calculates a post-filter filter parameter on an area-by-area basis based on said characteristic quantity.

9. The moving image decoding method according to claim 8, wherein:
said calculation step compares said characteristic quantity and a predetermined threshold value, and calculates a noise elimination intensity on an area-by-area basis as said filter parameter; and
said post-filter processing step applies said noise elimination intensity to a post-filter and processes a noise component of decoded data of said priority-coded data.

10. The moving image decoding method according to claim 9, wherein said calculation step increases a noise elimination intensity when said characteristic quantity is smaller than said threshold value, and decreases a noise elimination intensity when said characteristic quantity is greater than said threshold value.

11. The moving image decoding method according to claim 7, wherein:
said calculation step uses a noise elimination intensity as a filter parameter calculated based on said per-area characteristic quantity and calculates a per-area difference of said filter parameter, and calculates a modification value that corrects said noise elimination intensity on a pixel-by-pixel basis using said difference; and
said post-filter processing step corrects a post-filter noise elimination intensity based on said modification value, and applies a noise elimination intensity after said modification to a post-filter and processes said noise component of decoded data of said priority-coded data.

12. The moving image decoding method according to claim 7, wherein:
said calculation step calculates said post-filter noise elimination intensity on an area-by-area basis, and also stores a noise elimination intensity each time that calculation is performed and corrects a calculated noise elimination intensity using a stored past noise elimination intensity; and
said post-filter processing step sets a post-filter noise elimination intensity based on said corrected noise elimination intensity and processes said noise component of decoded data of said priority-coded data.
